(19) United States
(12) Patent Application Publication
(10) Pub. No.: US 2009/0043690 A1
(43) Pub. Date: Feb. 12, 2009

(54) SYSTEM AND METHOD FOR VALIDATING INDIRECT FINANCING TRANSACTIONS

(76) Inventors: Paul MacLellan, Brighton, MI (US); Barry McMillan, Markham (CA)

Correspondence Address: THELEN REID BROWN RAYSMAN & STEINER LLP, PO BOX 640640, SAN JOSE, CA, 95164-0640, US

(21) Appl. No.: 11/834,378

(22) Filed: Aug. 6, 2007

(51) Int. Cl. G06Q 40/00; G06F 17/30; G06F 17/40

(52) U.S. Cl. 705/38

(57) ABSTRACT

A computer-implemented system and methods for electronically validating indirect financing transactions using various validation rules are described. The system is configured to collect from various independent finance sources information about available automobile financing programs, including various credit application validation rules. The system receives from automobile dealer credit application information, which may be provided via one or more electronic worksheets. The system validates accuracy of the application data using pre-submission validation rules and forwards the validated credit application to the associated finance source for approval. After submission of the credit application for approval, the system may receive additional changes to the application from the dealer. The system is configured to validates accuracy of the changed information using post-submission validation rules and notify the finance source if any validation rules were violated by the dealer.

### TECHNICAL FIELD

The present invention relates generally to indirect financing transactions, such as automobile financing by various independent finance sources, and more particularly, to rule-based validation of such indirect financing transactions.

### BACKGROUND

Advancements in the computer and telecommunication technologies, have had a significant impact on the way businesses conduct, financial transactions. For example, the exchange of electronic information and messaging in retail applications, especially in the world of vehicle sales, has become commonplace. Dealership employees (e.g., finance and insurance staff) have the capability of electronically initiating one or more financial loan transactions for their customers with various independent finance sources, thereby enhancing both the efficiency and accuracy associated with securing such loans. With this in mind, it may be advantageous to perform validation of such indirect financing transaction at various stages of the transaction, thereby eliminating or greatly reducing the likelihood of a finance source approving an automobile loan based on incorrect/invalid information relating to the available financing programs and other data.

### OVERVIEW

Disclosed are computer-implemented system and methods for indirect financing of an acquisition by a customer of an asset, such as a vehicle, offered by a vendor with financing provided by an independent finance source. In one example embodiment, the system includes a database comprising finance source information for each of a plurality of finance sources. The finance source information corresponding to each of the finance sources includes one or more finance source specified rules to be applied to information in a credit application to the finance source. The system further includes a credit aggregation management system providing access to the finance source on behalf of the customer seeking the credit approval. The credit aggregation management system facilitates acquisition of the credit approval from the financial source by receiving credit application information from the vendor. The system further includes a credit application validation engine operable to validate at least a portion of the information included in the credit application by applying to the information at least one of the one or more finance source specified rules for at least one finance source before submitting a credit application to the at least one finance source for approval.

The finance source specified rules may include one or more validation error rules. When violation of a validation error rule is detected, the credit aggregation management system is configured not to submit the credit application to the at least one finance source until the invalid portion of information in the credit application is corrected by the vendor. The finance source specified rules further include one or more validation issue rules. When violation of a validation issue rule is detected, the credit aggregation management system is configured (i) to submit the credit application to the at least one finance source for approval and (ii) notifying the finance source of violation of at least one finance source specified validation issue rule.

After submitting the credit application to the at least one finance source for approval, the credit application validation engine is configured (i) to receive from the vendor one or more changes to the information submitted in the credit application and (ii) to validate at least a portion of the changed information by applying to the information at least one of the one or more finance source specified rules.

In another exemplary embodiment, disclosed is a method for indirect financing of an acquisition by a Customer of an asset offered by a vendor with financing provided by an independent finance source. The method includes storing finance source information for each of a plurality of finance sources. The finance source information corresponding to one or more finance sources including one or more finance source specified rules to be applied to information in a credit application to the finance source. The method further includes acquiring, via a computer operated by the vendor, information for inclusion in the credit application and validating, before submitting a credit application to the at least one finance source, at least a portion of the information included in the credit application by applying to the information one of the one or more finance source specified rules and one of one or more global validation rules, the global validation rules being applied to credit applications to a plurality of finance sources.

The method further includes generating a credit application for financing the asset for acquisition by the customer and submitting the generated credit application to the at least one finance source. After submission of the credit application to the at least one finance source, receiving from the vendor one or more changes to the information in the submitted credit application and validating the one or more received changes to the information in the submitted credit application by applying to the information one of the one or more finance source specified rules and one or more global validation rules. The method further including detecting a violation of at least one of the one or more finance source specified rules and notifying the finance source of the violation.

Yet in another example embodiment, disclosed is another method for indirect financing of an acquisition by a customer of an asset offered by a vendor with financing provided by an independent finance source. The method includes storing, one or more credit application validation rules, including pre-submission validation rules and post-submission validation rules. The pre-submission and post-submission validation rules include finance source rules specified by at least one finance source to be applied to the information in the credit application to the finance source. The pre-submission and post-submission validation rules include global validation rules, which are applied to information in credit applications to a plurality of finance sources. The pre-submission and post-submission validation rules further include validation error rules and validation issue rules.

The method further includes receiving, via a computer operated by the vendor, information for inclusion in a credit application for financing the asset for acquisition by the customer. Prior to submitting a credit application to the at least one finance source, validating at least a portion of the information included in the credit application by applying to the information at least one of the one or more pre-submission validation rules, including pre-submission validation error rules and pre-submission validation issue rules. In the event of violation of at least one pre-submission validation error rule, delaying submission of the credit application to the at least one finance source until the invalid information is corrected by the vendor. In the even of violation of at least one pre-submission validation issue rule displaying on the computer operated by the vendor a status indication associated with rule violation and submitting the credit application to the at least one finance source along with a notification of violation of at least one pre-submission validation issue rule.

After submitting the credit application to the at least one finance source, receiving one or more changes to the information in the submitted credit application and validating the one or more received changes to the information by applying to the information at least one of the one or more post-submission validation rules, including post-submission validation error rules and post-submission validation issue rules. In the event of violation of at least one post-submission validation error rule, requesting the vendor (i) to resubmit the credit application to the finance source for approval, or (ii) to modify the changed information such that it complies with post-submission validation error rules. In the event of violation of at least one post-submission validation issue rule, notifying the finance source of rule violation. After receiving an approval of the credit application from a finance source, validating the at least one of credit application information and a credit decision information by applying at least one of one or more post-submission validation error rules and one or more post-submission validation issue rules.

### BRIEF DESCRIPTION OF DRAWINGS

The accompanying drawings, which are incorporated into and constitute a part of this specification, illustrate one of more examples of embodiments and, together with the description of example embodiments, serve to explain the principles and implementations of the embodiments.

In the drawings:

FIG. 1 illustrates a schematic diagram of a system for implementing financing transactions in connection with an acquisition of a vehicle, in accordance with an embodiment of the present invention;

FIG. 2 illustrates a schematic diagram of a database of a credit aggregation management system, in accordance with some embodiment of the present invention;

FIGS. 3-5 are operational flow diagrams of processes for facilitating vehicle financing transactions in accordance with various embodiments of the present invention; and

FIGS. 6-8 are exemplary dealer interfaces facilitating implementation of vehicle financing transactions in accordance with various embodiments of the present invention.

### DETAILED DESCRIPTION OF EMBODIMENTS

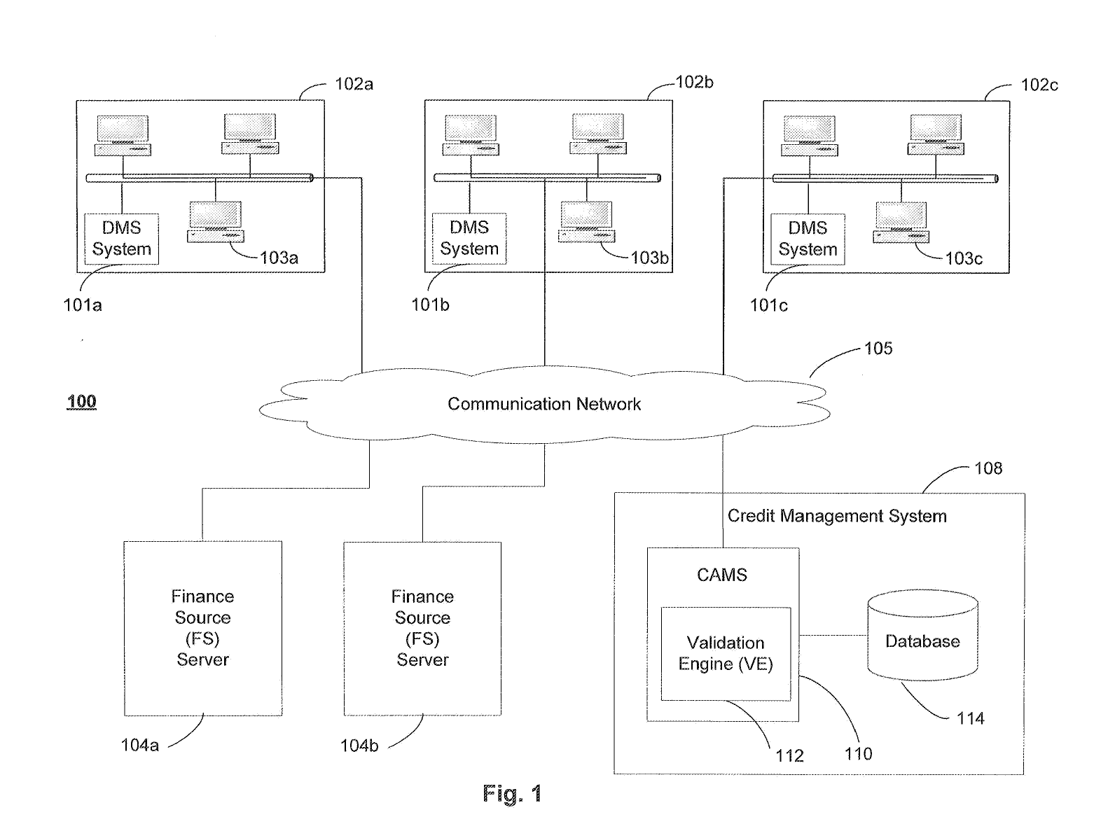

As will be understood, for purposes of clarity of exposition, the illustrative embodiments described herein in connection with FIGS. 1-8 relate to system and methods for facilitating indirect financing transactions, such as buying or leasing an automobile offered for sale or lease by an automobile dealership with financing provided by one or more independent finance sources. Embodiments of the present invention, however, are not limited to such automobile retail environments and automobile vehicle financing applications, but may be implemented in myriad other commercial transaction environments and asset financing, transactions, including both unsecured and secured credit applications and financing. Furthermore, vehicle financing transactions may involve vehicles other than automobiles (e.g., including cars and trucks), such as boats and other watercraft or marine vehicles, recreational vehicles, motorcycles, off-road vehicles, and aircraft.

A financing transaction, as used herein, may be a lease transaction, a loan transaction, or any other transaction in which a finance source provides financing for a party to obtain use of, and possibly also legal title to, an asset, which asset includes, for example, one or more items such as automobiles (e.g., cars, trucks, etc.), marine, recreational vehicles (RV), aircraft, motorcycles, off-road vehicles, consumer goods, real estate, contract rights, intangible property rights, home furnishings, home improvement, office equipment, inventory, manufacturing equipment, livestock farm equipment, financial interests, etc. Additionally, for convenience, as used wherein, the term “acquisition” used in connection with an asset (e.g., an “asset acquisition” or “acquiring an asset”) may involve a purchase (i.e., buying or a corresponding sale) or a lease of the asset, and thus a financing transaction relating to an acquisition may be a lease transaction, a loan transaction, or any other transaction in which a finance source provides financing for a party to obtain use of, and possibly also legal title to, the asset.

Additionally, while the ensuing embodiment is described in connection with a transaction involving personal communication (e.g., face-to-face, telephonic, etc.) between a customer and a dealer at a brick-and-mortar dealership, alternative embodiments of the present invention may be implemented in an e-commerce or online shopping environment (e.g., online automobile dealer), where a customer may remotely browse an online retailer's website for locating and, buying or leasing inventory offered for sale or lease by the online retailer, though such e-commerce or online shopping may also involve some communication between customer and an employee or human agent of the online dealer (e.g., to obtain additional information and/or effect all or part of the transactions). Furthermore, a dealer is not limited to an automobile dealer, but is any individual or entity (e.g., commercial dealership, third party brokers, vendors, retailers, and manufacturers) in the business of selling or leasing assets, including merchandise, to customers, and in doing so may communicate with lenders as well as customers.

FIG. 1 illustrates a system 100 according to an embodiment of the invention, where the system comprises automobile dealership computer systems 102a, 102b, 102c, finance source (FS) systems 104a, 104b, and a credit management system (CMS) 108. Communications between the various dealerships 102, FS systems 104 and CMS systems 108, as may be required according to various embodiments of the present invention, are provided via communications network 105, which may include any configuration of private and/or public communication networks, packet switched local area networks (LAN) and wide area networks (WAN). In the illustrative embodiment network 105 includes the Internet. Dealership, FS, and CMS systems may communicate using messaging formats and protocols know in the art, such as XML-based messaging according to STAR (Standards for Technology in Automotive Retail) and the like.

In accordance with various embodiments, finance source (FS) systems 104 provide processing platforms for processing credit applications for financing (e.g., loans and/or leases) an automobile being offered for sale by a dealer to a customer. Examples of finance sources 104 include Lexus Financial Bank®, BMW Financial Services, General Motors Acceptance Corporation (GMAC®) Financial Services and others. Embodiments of the present invention, however, are not limited to such automobile retail environments and automobile vehicle financing applications, but may be implemented in myriad other commercial transaction environments and asset financing transactions, including both unsecured and secured credit applications and financing. Accordingly, a finance source (also referred to herein as a lender) may be considered as any entity providing financing for asset (e.g., automobiles in the illustrative embodiment of FIG. 1) transactions, e.g., banks and credit unions, manufacturer-related financing companies, financial institutions, and other credit granting institutions.

In various embodiments, dealerships 102 may be independent automobile dealerships (e.g., separately owned businesses) and, as schematically depicted, each including a computer network comprising one or more computer devices 103 communicably coupled to a Dealer Management System (DMS) 101, which may be operating on one or more servers on the dealership's computer network. As will be, understood by those skilled in the art, the illustrative dealership computer devices 103 are not limited to personal computers, terminals, or workstations, nor limited to wired network connections within the dealership, but may include any computing device that may communicably connect (e.g., wirelessly; via a WAN, via a virtual private network (VPN) connection, via the Internet, etc.; via one or more hardware devices, such as routers, switches, hubs, etc.; and using any of a variety of communication protocols; etc.) to the Dealer Management, System 101.

As known to those skilled in the art, a typical DMS 101 (e.g., such as provided by ADP, Inc. or Reynolds and Reynolds, Inc.) or similar system stores and manages dealership data such as that related to inventory, sales, parts, service, customers, etc. In use, the DMS 101 allows salespersons, management, and other authorized users to access stored dealership data. For example, a salesperson may access the DMS via a computer device (e.g., 103a) to determine whether the dealership has a certain vehicle in its existing inventory. In addition, as will be further understood below, in various embodiments of the invention, a dealer assisting a customer in arranging for financing to complete the automobile transaction (e.g., lease or sale) may use a dealership computer 103 to access the DMS 101 to acquire vehicle information (and possibly also information for a return customer), and may also access (e.g., navigating via a web browser) credit management system (CMS) 108 (e.g., which may be web-based) to arrange for financing of the vehicle from a finance source 104.

In accordance with various embodiments, the credit management system (CMS) comprises one or more computer servers connected to the communication network 105. CMS computer system 108 may be provided by an independent application service provider (ASP), though in various embodiments such a system may be provided, for example, by one or more affiliated dealers. In an embodiment of the invention, CMS 108 is operable to assist automobile dealers in obtaining automobile financing for customers from disparate finance sources 104. To that end, CMS 108 maintains secure, separate accounts for each independent dealership participant (e.g., subscriber) of the credit management system, which automobile dealer may access via communication network 105 (e.g., via a secure (e.g., encrypted) communication link). To facilitate execution of financing transactions, the CMS 108 comprises a credit aggregation management system (CAMS) 110 and a database 114, as may be implemented in accordance with some embodiments of the presents invention.

CAMS 110 may be implemented as a web-based application, providing independent dealerships (e.g. 102a, 102b, 102c) a common platform for submitting automobile financing application information to one or more finance sources (e.g., finance sources 104a, 104b) with which they do business. In some embodiments, CAMS 110 is operable to collect from FS system 104 information about available automobile financing programs. In various embodiments, CAMS 110 is operable to receive from a dealer financing application information provided via one or more electronic worksheets CAMS 110 may validate accuracy of the worksheet data using pre-submission validation rules and forward the validated financing application to the appropriate finance source 104 for approval. Frequently, dealers make changes to the worksheet data after submission of the financing application to finance source and before or after approval of the application. In this ease, CAMS 110 may validate changed application data using post-submission validation rules. In addition, CAMS 110 may use post-submission validation rules to validate approved application data and credit decision data used by the finances source. Based on the validated and approved financing application, CAMS 110 may generate an automobile financing contract and provide the same to the dealer.

To facilitate execution of financing transactions between customers and finance sources 104, CAMS 110 is operable to collect from finance sources 104 and to store in the database 114 finance source (FS) profiles information 116. In some embodiments, a FS profile 116 may include, but is not limited to applicant worksheets 202, which may be used by dealers, to collect applicant personal information and vehicle information; deal worksheets 204, which may be used by dealers to collect financial information; financing programs information 206, which may include information on the term of available auto loans and leases, their amortization and interest rates and other financial parameters; and supplemental forms 208, which may include retail loan agreements, lease agreements and other financial forms, that may be provided to the customer in connection with the financing of the vehicle. In various embodiments, the finance source profile 116 may include finance source specified pre-submission validation rules 212; global pre-submission validation rules 214; finance source specified post-submission validation rules 216; and global post-submission validation rules 218.

In an embodiment, FS specified pre-submission validation rules 212 may be applied to the applicant worksheet and deal worksheet data to verify the validity thereof before a credit application is submitted to the FS 104 for approval. More specifically, for example, validation rules 212 may verify the validity of financial data associated with the financing transaction as well as vehicle-related data that may affect financing of the vehicle. Examples of FS specified pre-submission validation-rules 212 include, but are not limited to the following minimum residual value of the vehicle cannot be below 15% of adjusted MSRP; maximum allowable optional credit life insurance amount is $5000; maximum allowable disability insurance amount is $5000; for new vehicles, dealers may not mark up interest rates less than or equal to 3.9%; for new vehicles, mark up rate must not exceed 0.50% of the interest rate; for used vehicles, mark up rate must not exceed 1.00% of the interest rate; bed liner is only available for the following new vehicles (Silverado, Sierra, Colorado, and Canyon). It is understood to those of skill in the art, that the above validation rules are merely exemplary and are not limiting. For example, these illustrative validation rules (including the illustrative values) are merely representative of types of rules that may be implemented, and while one or more of these rules, or types of rules, may be included in various implementations, one or more other rules or types of rules may be additionally or alternatively implemented.

In some embodiments, system-specified global pre-submission validation rules 214 may be applied to the applicant worksheet data and deal worksheet data to verify the validity thereof before a credit application is submitted to the FS 104 for approval. In particular, global rules 214 may verify presence and validity of customer personal information as well as of some financial information not covered by the validation rules 212. Examples of global pre-submission validation rules 214 include, but are not limited to social security number must be exactly nine digits long; last and first names should not have any digits; total amount financed cannot be negative; buy down rate must be less than interest rate; mark up rate must be greater than interest rate; selection of a financing program is required; inception mileage is required for all used vehicles; if the customer traded in a lease vehicle, the dealer must not be able to enter a gross trade-in allowance and lien payout amount. It is understood to those of skill in the art that the above validation rules are merely exemplary and are not limiting.

It will also be understood by those skilled in the art that as a credit application includes information based on the applicant worksheet data and/or deal worksheet data (e.g., the credit application information may include at least some data identical to and/or calculated or otherwise derived from at least a portion of applicant worksheet data and/or deal worksheet data), verifying the validity of data upon which credit application information is based in advance of submitting the credit application to the finance source reduces the likelihood of submitting to a finance source a credit application containing errors that may affect financing approval and/or require correction at the dealer/customer end.

In some embodiments, FS specified post-submission validation rules 216 may be applied to the changed deal worksheets, approved credit applications, and credit decision data to verify the validity thereof before or after a credit application is reviewed and approved by the finance source 104. In particular, validation rules 216 may be used to verify the validity of financial data associated with the financing transaction as well as vehicle-related data that may affect the financing arrangement. Examples of global pre-submission validation rules 216 include, but are not limited to a rule indicating that vehicle descriptions (e.g., Year, Make, Model, Style/Trim, Series) entered before application submission do not match the current VIN decoded descriptions, (Year); a rule indicating that the total amount financed cannot exceed lender specific (10%) of the total amount financed returned in the credit decision; a rule indicating that payments cannot, exceed 15% the approved payment amount; a rule indicating that delivery date must be on or after the current date. It is understood by those of skill in the art, that the above validation rules are merely exemplary and are not limiting.

In some embodiments, system-specified global post-submission validation rules 218 may be applied to the approved credit application, the applicant worksheet data, as well as to the credit decision data to verify the validity thereof after the application has been approved. In particular, global rules 218 may verify presence and validity of customer personal information as well as of some financial information not covered by the validation rules 216. Unlike FS specified validation rules 216, global rules 218 may not be finance source specific and may apply globally to verify data in different transactions. Examples of global post-submission validation rules 214 include, but are not limited to: a rule indicating that vehicle descriptions (e.g., year, make, model, style/trim, series) entered pre-submission do not match the current VIN decoded descriptions (year); a rule indicating that delivery date must be on or after the current date, and other rules. It is understood by those of skill in the art, that the above global post-submission validation rules are merely exemplary and are not limiting.

In some embodiments, various validation rules may be divided into two categories based, for example, on the severity of violation and system response thereto. The first category of rules may be referred to as validation issue rules. The validation issue rules include those rules the violation of which does not preclude a dealer from completing and submitting a credit application to the finance source 104 for approval. In particular, violation of a validation issue rule results in CAMS 110 generating a warning message indicating that the rule was violated. The dealer can, however, disregard this warning message and proceed with submission of the application to the finance source 104 for approval. Likewise, in the post-submission validation stage, the dealer can disregard a warning message and generate a financing contract ready for customer signature. In the event that the dealer disregards a warning message, the CAMS may send a message to the FS 104 notifying that a Validation issue rule was violated. In another embodiment, the CAMS may print on the contract document one or more error codes indicating which validation issue rules were violated by the dealer. Examples of validation issue rules include, but are not limited to the following: For new vehicles, mark up rate must not exceed 0.50% of the interest rate; payments cannot exceed 15% above the approved payment amount.

In such embodiments, a second category of rules may be referred to as validation error rules. The validation error rules include those rules violation of which precludes a dealer from completing and submitting a credit application to the finance source 104 for approval. In particular, violation of a validation error rule results in CAMS 110 generating, an error message indicating that the rule was violated. The dealer cannot disregard this error message and must correct the indicated error before submitting the credit application to the finance source 104 for approval. Likewise in the post-submission validation stage, the dealer cannot disregard an error message generated as a result of violation of a post-submission application validation error rule. The dealer has two options: (1) the dealer may correct the indicated error in the dealer worksheet to comply with the approved deal structure, or (2) resubmit the changed credit application for re-approval by the finance source 104. Examples of validation error rules include, but are not limited to the following: minimum residual value cannot be below 15% of adjusted MSRP; Saturn, Saab and Subaru vehicles may not be marked up; vehicle descriptions entered pre-submission do not match the current VIN decoded descriptions (e.g., Year).

The FS profile information stored in database 114 may be provided by financial systems 104 in the following manner: In some embodiments, the finance source profile information may be orally communicated to the CMS administrators by representatives of finance sources 104. System administrators may then manually enter the provided information into FS profiles 116 and code various credit application validation rules using conditional expressions using, for example, Java, C++, Drools, JESS or other known programming language. Alternatively or additionally, CMS 108 may provide a graphic user interface, such as a webpage, by which FS representatives may submit information into the CMS 108. Some embodiments may provide for the CAMS 116 exposing a plurality of application program interfaces (API), such as XML-based APIs, which can be used by the FS 104 to design custom user interfaces to the CMS 108 for submission of FS information. Finance source profile information may be periodically (e.g., hourly, daily, weekly, etc.) updated by finance sources 104 to reflect changes to business objectives, financial arrangements and economic conditions associated with financing of vehicles. Such changes may include, for example, changes to one or more of interest rates, tax rates, limits of financing amounts, special promotions (e.g., 0% APR for 6 months), as well as other parameters.

To facilitate validation of credit application data, the CAMS 110 includes a credit application validation engine (VE) 112. The VE 112 may be implemented as a module included within the CAMS system, though as will be understood by those skilled in the art, the credit application validation functionality may be provided as a separate application running on the same or different server as the CAMS application. In an embodiment, VE 112 is operative to perform pre-submission and post-submission validations of vehicle financing applications (e.g., credit applications). More specifically, VE 112 is operable to perform application validation based on FS specified validation rules and, as, implemented in the illustrative embodiment, is also operable to perform application validation based on system-specified global validation rules. To that end, the VE 112 is operable to retrieve from FS profiles 116 various validation rules and other information, such as the current financing program interest rates, vehicle residual value data, loan amortization data and the like, and use the retrieved information and rules to validate credit application data.

In one embodiment, during pre-submission data processing (e.g., before application is sent to FS 104 for approval), VE 112 is operable to validate the applicant worksheets and deal worksheets data against FS-specified pre-submission validation rules 212 and system-specified global pre-submission validation rules 214. In the event that a pre-submission validation rule 212 is violated, the VE 112 may generate various error and/or warning messages, which, may depend on the type of rule that was violated. If a validation error rule was violated, an error message may displayed, instructing the dealer that the entered data is incorrect and must be reentered before application can be submitted to the finance source for approval. If a validation issue rule was violated, a warning message may be displayed, notifying the dealer that entered data may be incorrect. In the event that all pre-submission validation rules 212 have been complied with, the VE 112 instructs CAMS 110 accordingly, and CAMS 110 may generate a credit application based on the validated applicant worksheet and deal worksheet data and send the generated credit application for approval to the finance source 104.

In another embodiment, during post-submission application processing (e.g., after credit application was submitted to the finance source and before or after it has been approved), VE 112 is configured to validate data in dealer worksheet to assure that any changes made by the dealer to the structure of the deal while financing application has been undergoing approval process do not violate FS-approved deal structure or any post-submission application validation rules 216 and 218. In addition, validations rules 214 may be used by VE 112 to verify accuracy of approved credit application and credit decision data. In the event that a post-submission validation rule 214 is violated, the VE 112 may generate error and/or warning messages, which depend on the type of rule that has been violated. If a validation error rule were violated, an error message may be displayed, instructing the dealer to correct invalid application data and to resubmit the credit application to the FS 104 for approval. If a validation issue rule were violated, a warning message may be displayed, notifying the dealer that entered data may be incorrect. The dealer may correct invalid data or disregard the warning and print the financing contract. In the latter case, the VE 112 may send a message to the finance source, indicating which validation issues rule was violated. In addition, VE 112 may instruct CAMS 110 to add one or more codes to financing contract indicating which validation rules were violated by the dealer. In the event all post-submission validation rules 214 have been complied with the CAMS 110 may generate a financing, contract based on the approved application data and print it for customer's signature.

As indicated above, while CMS computer system 108 is depicted as a computer server 108, generally, CMS 108 may be implemented as, or be part of, a multi server environment having access to multiple databases to provide such a platform (e.g., including geographically dispersed servers to provide service to geographically dispersed dealers). Although the CAMS 110 is illustrated as being hosted by the web server 108, the application 110 may reside in other locations in the system 100. For example, in various alternative embodiments, the CAMS 110 may reside locally in the dealership (e.g., on a dealership LAN server and/or locally on a dealer workstation or other desktop computer). In some embodiments, one or more of these modules, or portions thereof, may be incorporated into a dealership's local DMS (e.g., DMS 101a). Additionally, in various embodiments, the DMS system, or portions thereof, may be implemented as a web-based service, similar to the CMS 108, and in some implementations such a web-based DMS system, or portions thereof, may be bundled or included with, or otherwise operate as part of, the web-based CMS 108. In short, the particular details of the system 100 may vary depending upon the particular application or embodiment of the present invention.

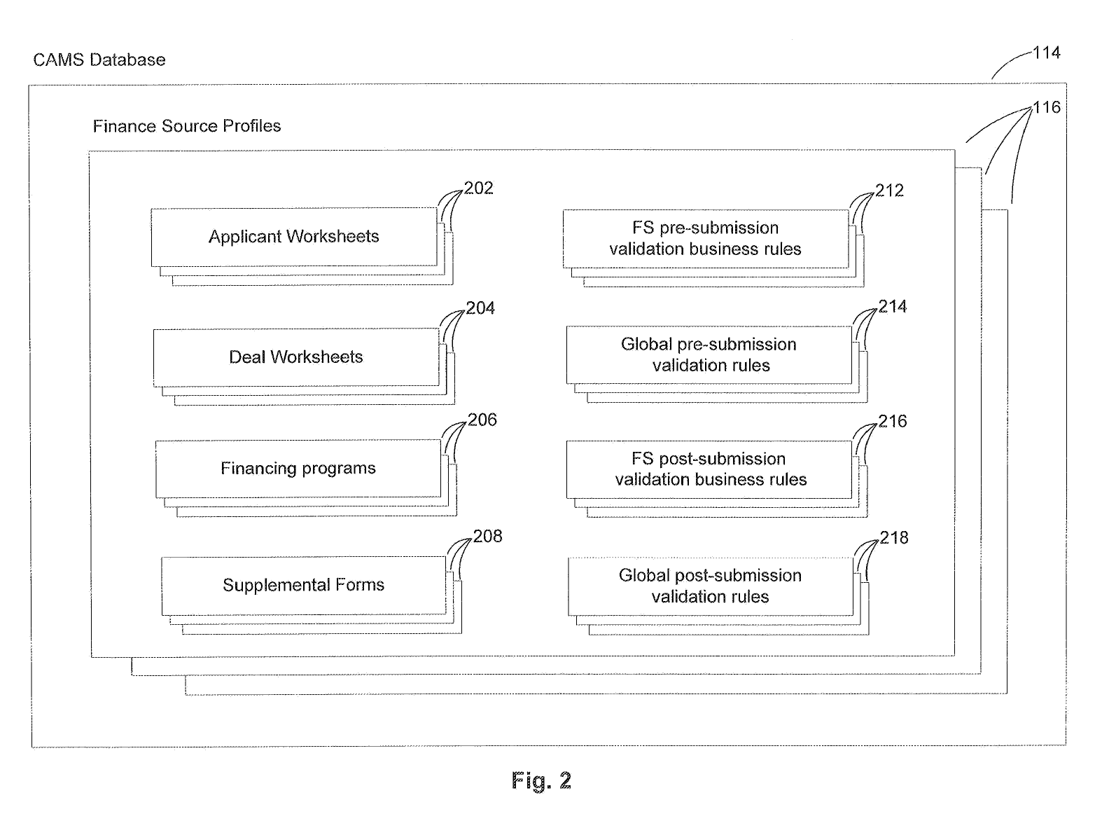

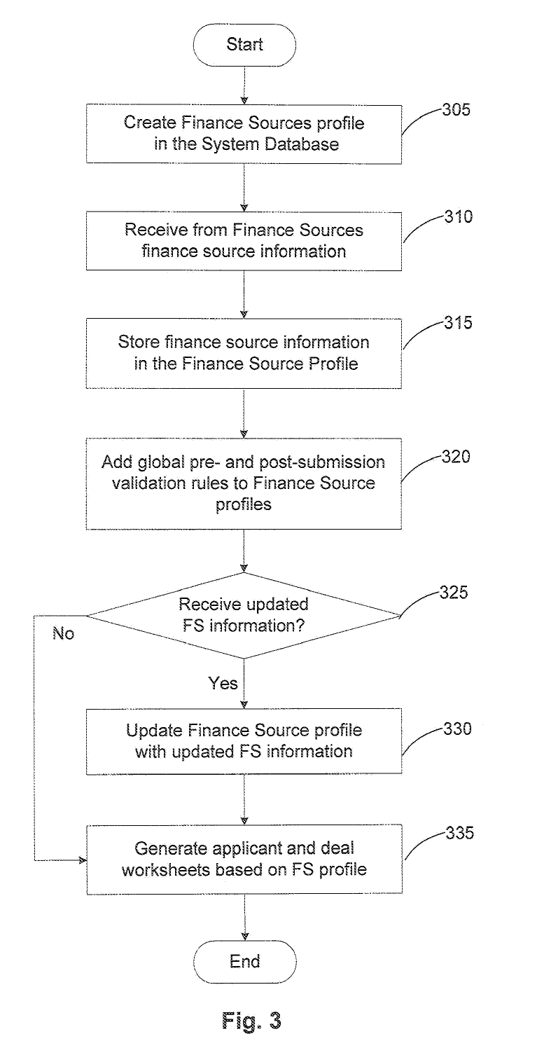

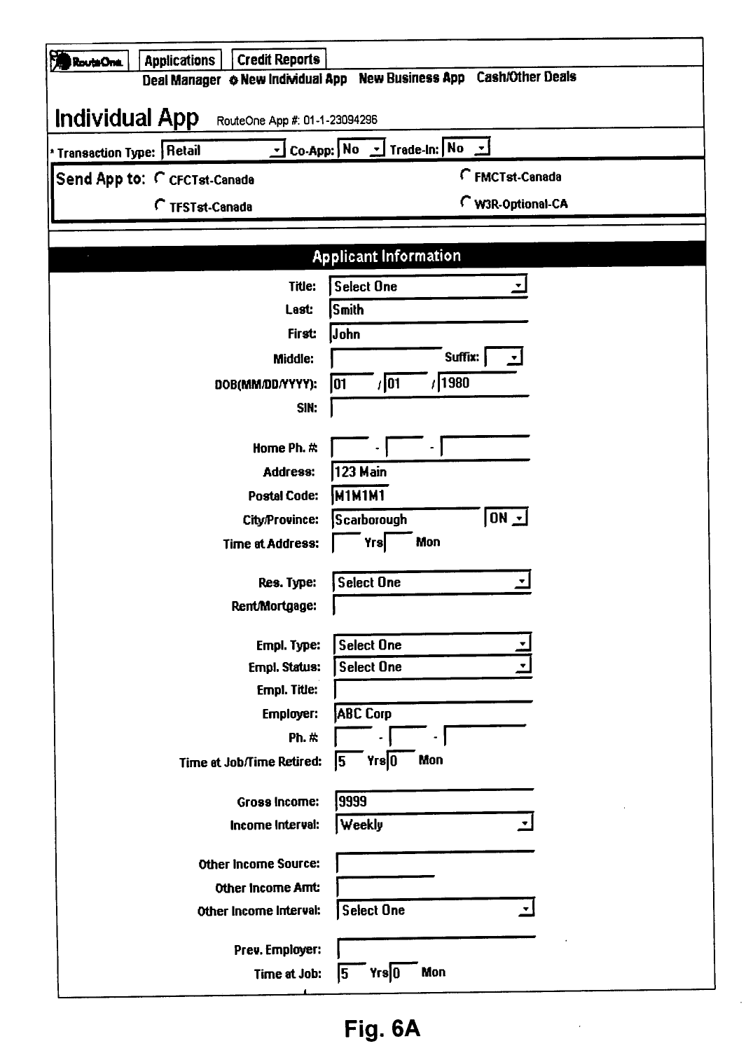

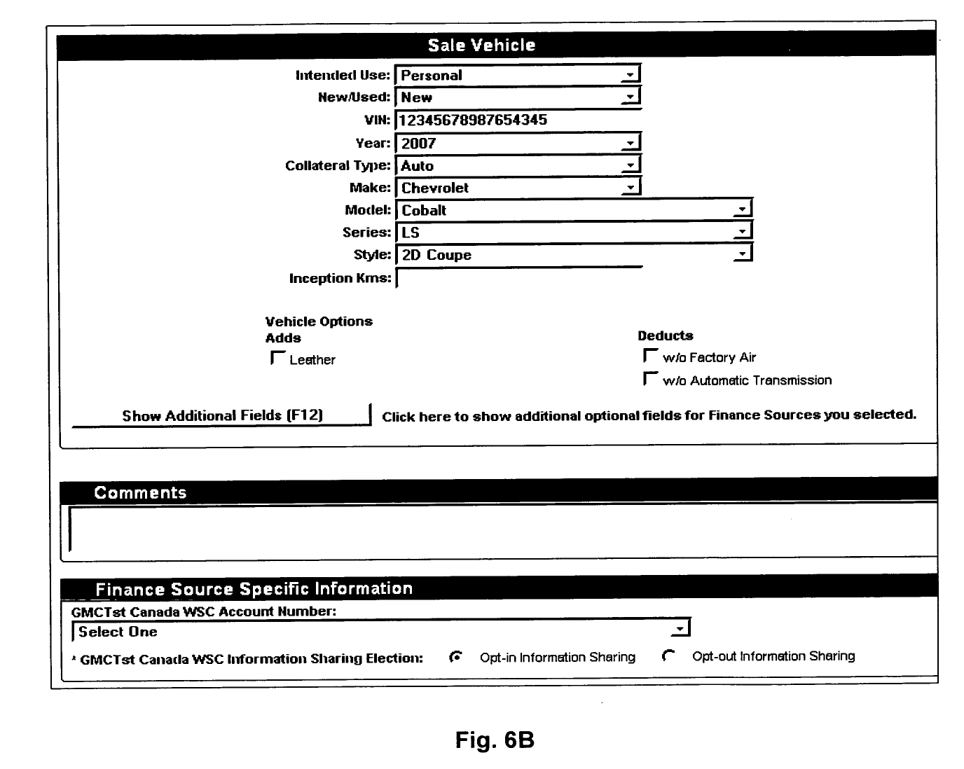

FIGS. 3-5 are operational flow diagrams of embodiments of a process for obtaining financing from a finance source in connection with a customer's acquisition (e.g., involving a sale or a lease) of a vehicle from a dealer. The operational steps of the financing process of FIGS. 3-5 will be described herein with reference to system 100 (FIGS. 1-2) and a set of exemplary webpage screen shots (FIG. 6-8).

With reference to FIG. 3, at step 305, Credit Aggregation Management System (CAMS) 110 creates Finance Source profiles 116 in the CAMS database 114 for each new Finance Source 104, which may be used to provide financing to customers for purchase or lease of automobiles from Dealerships 102. Once FS profile 116 is created, FS 104 may provide information about finance source, step 310, which is to be stored by CAMS 110 in FS profile 116, step 315. The provided information may include, but is not limited to, applicant worksheets 202, which may be used by dealers to collect customers' personal information; deal worksheets 204, which may be used by dealers to collect financial and vehicle information; financing programs information 206, which may include information on the term of available auto loans and leases, their amortization and interest rates and other financial parameters; supplemental forms 208, which may include various financial forms that may be provided to the customer in connection with the vehicle financing; FS specified pre-submission validation rules 212; and FS specified post-submission validation rules 216. Having received FS information, CAMS 110 may add to FS profile 116 system-specified global pre-submission validation rules 214 and global post-submission validation rules 218, step 320. In, alternative embodiments, the system may add one or more validation rules 214 and 218 at the time a deal is validated by the validation engine 112.

At step 325, CAMS 110 may receive updated financing information from finance 104. The financial information may be periodically (e.g., hourly, daily, weekly, etc.) updated by finance sources to reflect changes to business objectives, financial arrangements and economic conditions associated with financing of vehicles; such change may include changes to the interest rates, tax rates, limits of financing amounts, special promotions (e.g., 0% APR for 6 months) and to other parameters. Finance sources may update information in FS profiles 116 in the following manner by orally communicating new information to the CMS administrators, who then update FS profiles 116; through a graphic user interface, such a webpage, provided by CAMS 110; or through custom interfaces generated based on the CAMS API, such as XML-based APIs. Having received updated financial information from FS systems 104, CAMS 110 updates the associated FS profiles 116 with the new information, step 330. Lastly, at step 335, CAMS 110 generates applicant worksheet 202 and deal worksheets 204 based on the FS profile information and worksheet templates generated by the system administrators and stored in database 114.

FIG. 6 illustrates an exemplary embodiment of an applicant worksheet 202. As depicted, applicant worksheet 202 comprises a HTML webpage that facilitate collection of applicant' personal information and vehicle information. In an embodiment, CAMS 110 may use generic applicant worksheets which may be used to collect personal information typically used in vehicle financing transaction. For example, the standard applicant information may include, but is not limited to, applicant's name and year of birth, home address and phone number, current and previous employer information, income information and sources, as well as other types of personal information. The standard vehicle information may, for example, include, but is not limited to, vehicle's condition and intended use, vehicle's VIN number, year, make, model, series, style and other types of vehicle information. In some embodiments of the invention, CAMS 110 may use customized applicant worksheets. Such customized applicant worksheets 202 may be created by CAMS administrators to reflect particular needs and requirements of Finance Sources 104 and then stored in the FS profiles 116.

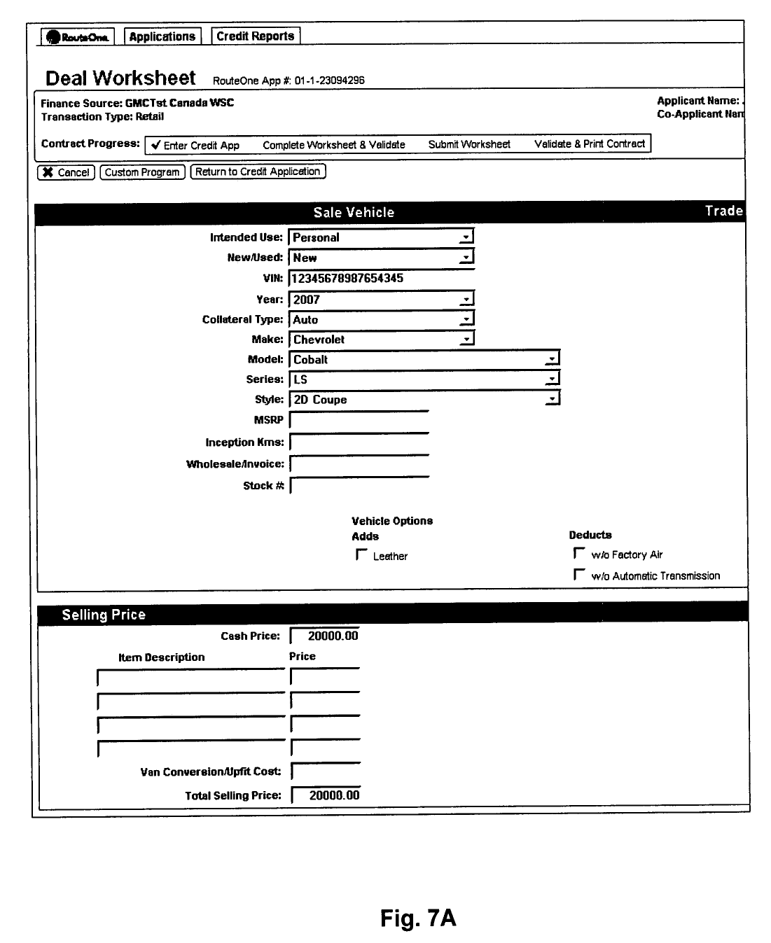

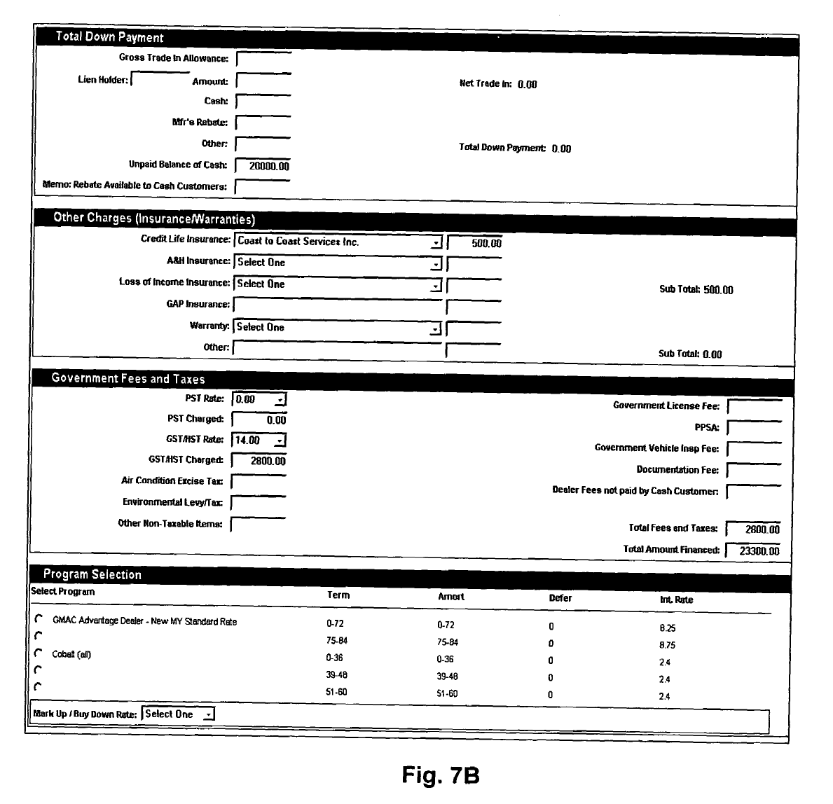

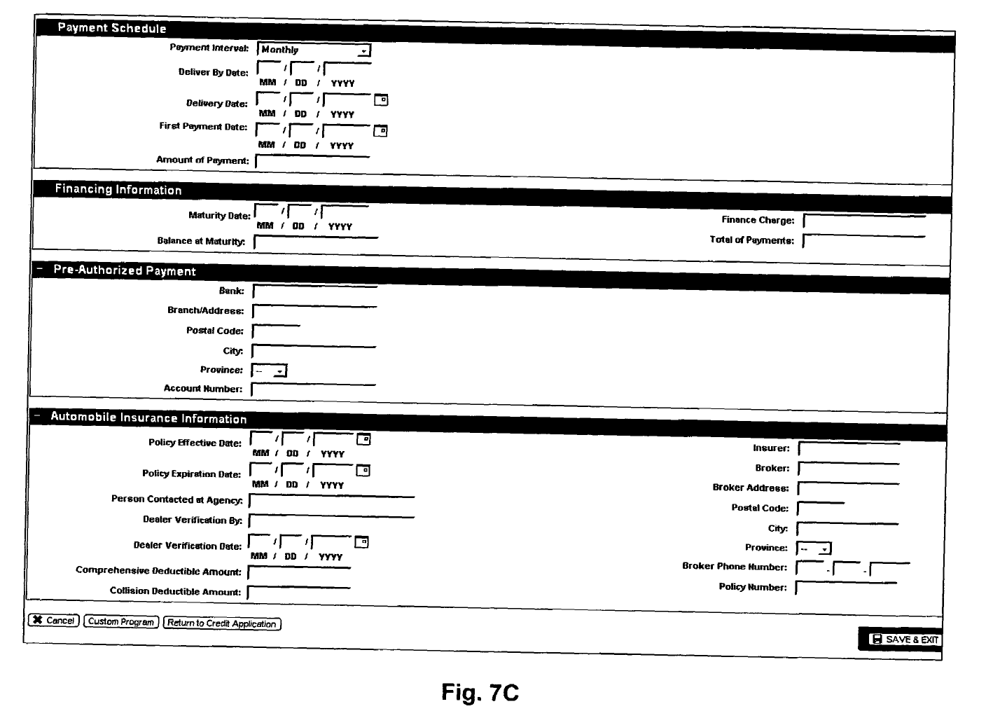

FIG. 7 illustrates an exemplary embodiment of a deal worksheet 204. As depicted, the deal worksheet 204 comprises a HTML webpage that facilitate collection of vehicle financing information and other financial information. In one embodiment, CAMS 110 may use generic deal worksheets, which may be used to collect financial information typically used in vehicle financing transaction. For example, the standard deal information may include, but is not limited to, sale price of the vehicle, trade in value, credit life insurance, warranties and government taxes. The deal worksheet 204 may also include, information about available financing programs, including term of financing amortization term and interest rate. The deal information may also include payment schedule, bank information and automobile insurance information. In some embodiments of the invention, CAMS 110 may use customized deal worksheets, which may be created by CAMS administrators to reflect particular needs and requirements of Finance Sources 104 and which are then stored in the FS profiles 116.

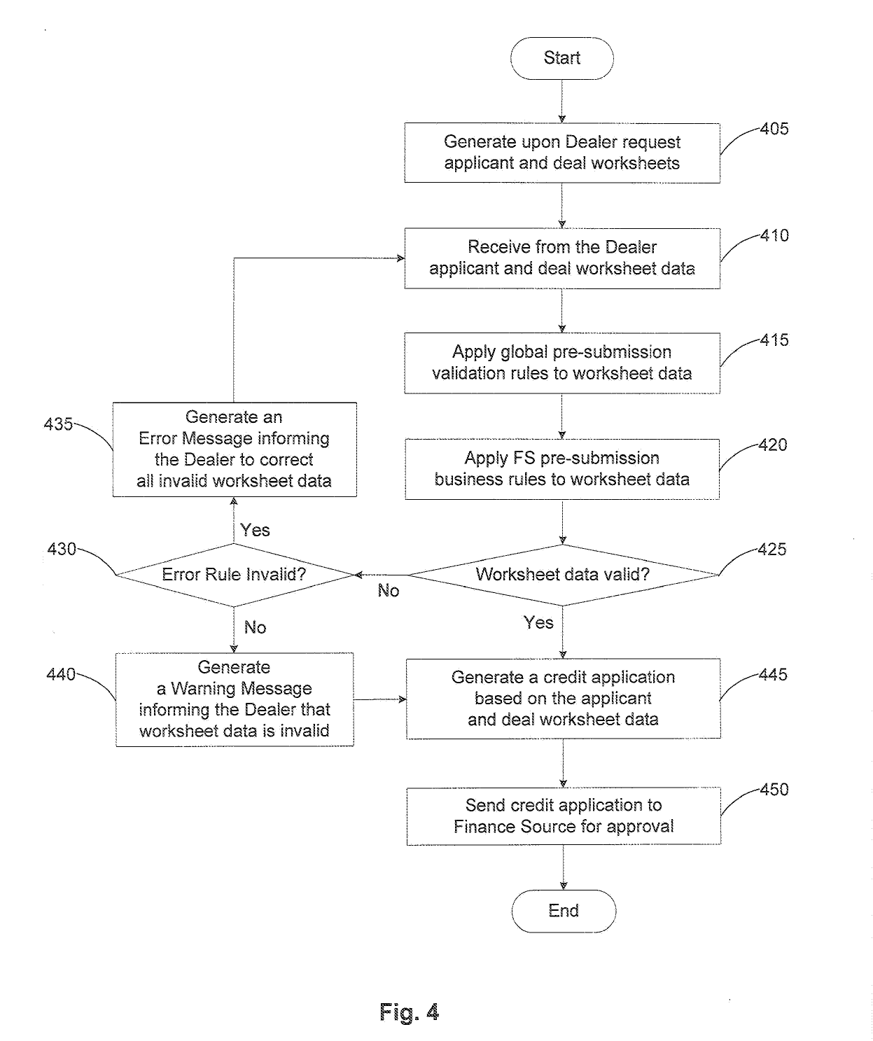

With reference to FIG. 4, having generated and a provided applicant and dealer worksheets to the dealer, step 405, CAMS 110 receives from the dealer information entered into, the worksheets data fields, step 410. CAMS 110 then activates a Validation Engine 112, which is operable to validates worksheets data against validation rules 212 and 214. In particular, at step 415, VE 112 retrieves from FS profile 116 global pre-submission validation rules 214 and applying the same to the worksheets data. Then, at step 420, VE 112 retrieve from FS profile 116 FS-specified pre-submission validation rules 212 and applies the same to the worksheets data. The pre-submission validation may be performed in real-time as the worksheet data is being entered by the dealer or after all data is entered and the dealer submits application for approval. In the event a pre-submission rule 212 or 214 is violated, step 425, VE 112 determines the type of violated rule, step 430. If a validation error rule is violated, VE 112 displays an error messages, instructing the dealer that the entered data is incorrect and must be reentered before application can be submitted to the finance source for approval, step 435. If a validation issue rule is violated, VE 112 displays a warning message, notifying the dealer that entered data may be incorrect, step 440. In the event that all pre-submission validation rules 212 and 214 have been complied with, step 425, VE 112 instructs CAMS 111 accordingly, and CAMS 110 may generate a credit application based on the validated customer and deal worksheet data, step 445. The generated credit application is then submitted for approval to the appropriate finance source 104, step 450.

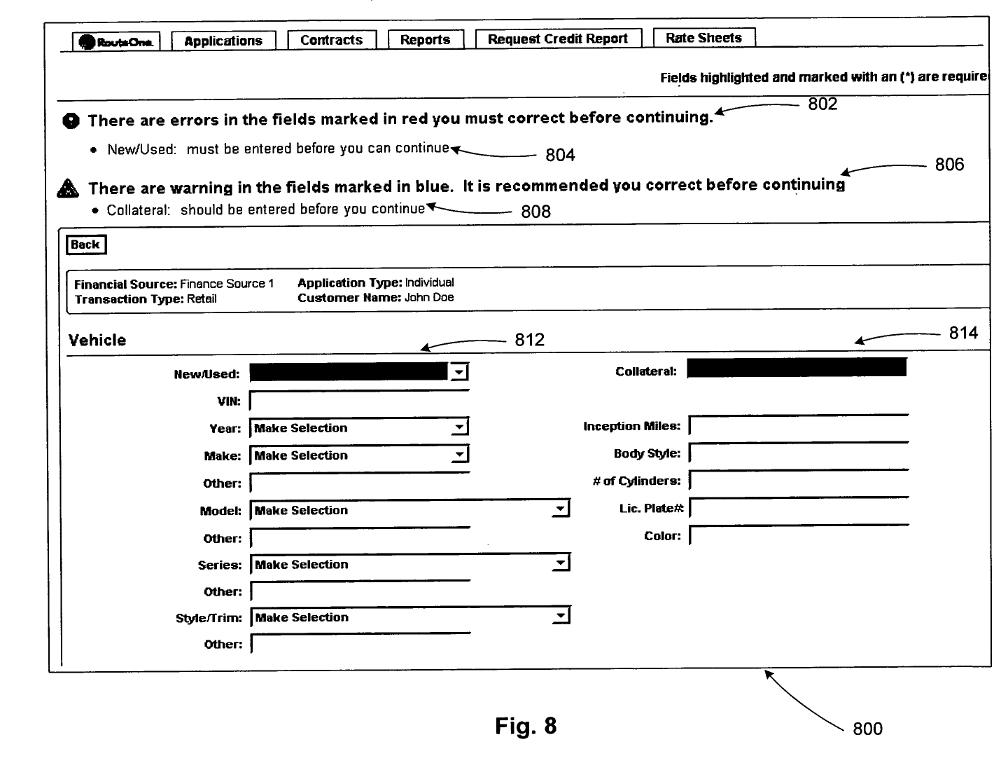

FIG. 8 illustrates an exemplary embodiment of a deal worksheet 800 showing two types of rules 804, 808 and the respective error messages 802, 806 that may be generated by VE 112 in response to violation of these rules. As depicted, the violation of the error rule 804 that requires that an appropriate data is entered into New/Used data field 812 before application can be submitted to a finance source 104 triggers error message 802: “There are errors in the field marked in red (field 812) you must correct before continuing.” Thus, the dealer must enter the appropriate data in to the field 812 to be able to apply for financing from FS 104. In contrast, the violation of the issue rule 808 that states that an appropriate collateral amount should be entered into Collateral data field 814 triggers warning message 806: “There are warnings in the field marked in blue (field 814). It is recommended you correct before continuing.” Thus, the dealer may enter the appropriate data in to the field 814. These validation rules and messages are merely exemplary; there are myriad other rules and messages that may be used in various embodiments of the present invention.

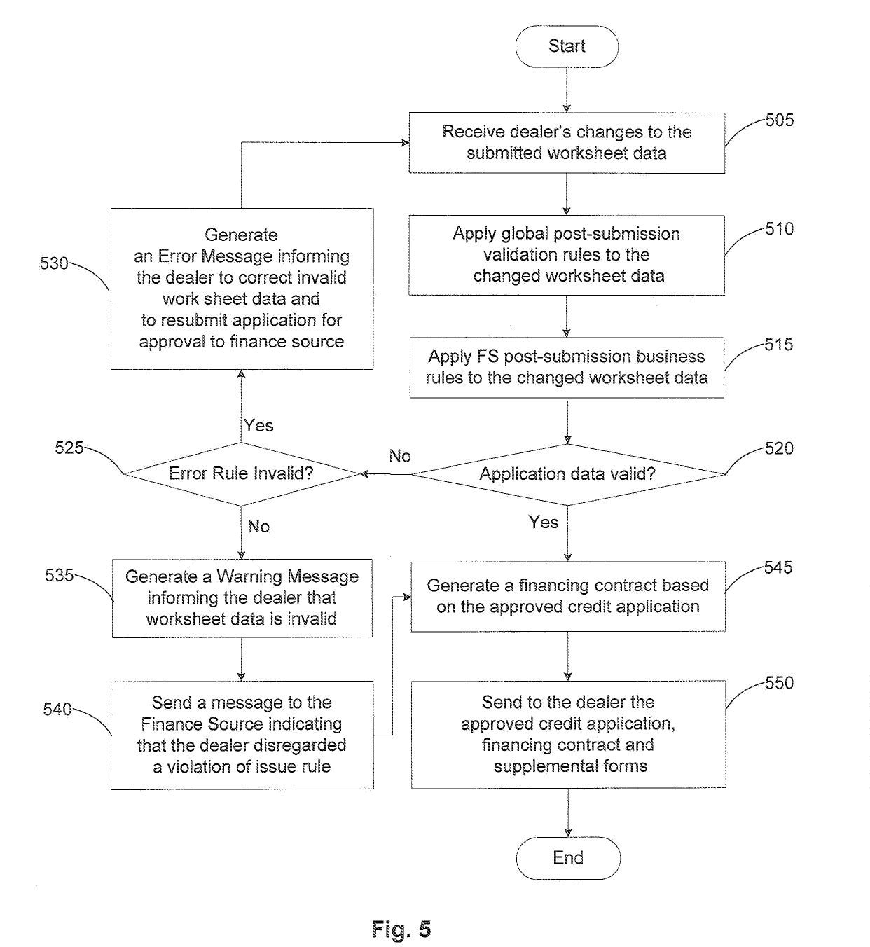

With reference to FIG. 5, depicted is a post-submission application validation process in accordance with one embodiment of the invention. A step 505, the dealer may make changes to deal structure by changing worksheet data after submission of the financing application to finance source 104 for approval but before or after approval thereof. In response, CAMS 110 is operative to activate a Validation Engine 112 to validate changes to the worksheet data made by the dealer. In particular, at step 510, VE 112 retrieves from FS profile 116 global post-submission validation rules 218 and applying the same to the changed worksheet data. Then, at step 515, VE 112 retrieve from FS profile 116 FS-specified post-submission validation rules 216 and applies the same to the changed worksheet data. In the event, a post-submission validation rule 216 or 218 is violated, step 520, VE 112 determines the type of the violated rule, step 525. If a validation error rule is violated, VE 112 displays an error message instructing the dealer to correct the invalid data and resubmit the credit application to the finance source 104 for approval, step 530. If a validation issue rule is violated, VE 112 displays a warning message, notifying the dealer that the changed data may be incorrect, step 535. If the dealer disregards the warning and leaves invalid data in the worksheet, VE 112 may send a message to the finance source 104 indicating that data was not corrected, step 540. In addition, VE 112 may instruct CAMS 110 to add an error code to the application indicating which validation rules were violated. The code may be placed in the footer or at the end of the application. In the event that all post-submission validation rules 216 and 218 have been complied with, step 520, VE 112 instructs CAMS 110 accordingly. In response, CAMS 110 may generate a credit contract based at least in part on the approved and validated application data, step 545. CAMS 110 may then send to the dealer the approved credit application along with financing contract and other supplemental forms 208.

While the invention has been described and illustrated in considerable detail with reference to certain preferred embodiments herein, other embodiments are possible. Additionally, as such the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments.

Systems and modules described herein may comprise software, firmware, hardware, or any combination(s) of software, firmware, or hardware suitable, for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via, other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements, from graphical user; interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

What is claimed is:

1. A method for indirect financing of an acquisition by a customer of an asset offered by a vendor with financing provided by an independent finance source, the method comprising:
storing finance source information for each of a plurality of finance sources, the finance source information corresponding to each of the finance sources including one or more finance source specified rules to be applied to information in a credit application to the finance source;
acquiring, via a computer operated by the vendor, information for inclusion in the credit application for financing the asset for acquisition by the customer; and
validating, before submitting a credit application to the at least one finance source, at least a portion of the information included in the credit application by applying to the information at least one of the one or more finance source specified rules.

2. The method of claim 1, wherein before submitting a credit application to the at least one finance source, validating at least a portion of the information included in the credit application by applying to the information at least one of one or more global validation rules, the global validation rules being applied to credit applications to a plurality of finance sources.

3. The method of claim 2, further comprising:
generating a credit application for financing the asset for acquisition by the customer; and
submitting the generated credit application to the at least one finance source.

4. The method of claim 3, wherein after submitting the credit application to the at least one finance source receiving from the vendor one or more changes to the information in the submitted credit application.

5. The method of claim 4, further comprising validating the one or more received changes to the information in the submitted credit application by applying to the information at least one of the one or more, finance source specified rules.

6. The method of claim 5, further comprising validating the one or more received changes to the information in the submitted credit application by applying to the information at least one of the one or more global validation rules.

7. The method of claim 6, further comprising
detecting a violation of at least one of the one or more finance source specified rules; and
notifying, in response to the detecting, the finance source of violation.

8. The method of claim 1, wherein the asset acquisition includes one of a lease and a purchase.

9. The method of claim 1, wherein the asset is a vehicle.

10. A method for indirect financing of an acquisition by a customer of an asset offered by a vendor with financing provided by an independent finance source, the method comprising:
storing one or more credit application validation rules, the validation rules including one or more pre-submission validation rules and one or more post-submission validation rules;
receiving, via a computer operated by the vendor, information for inclusion in a credit application for financing the asset for acquisition by the customer;
prior to submitting a credit application to the at least one finance source, validating at least a portion of the information included in the credit application by applying to the information at least one of the one or more pre-submission validation rules;
after submitting the credit application to the at least one finance source, receiving one or more changes to the information in the submitted credit application; and
validating the one or more received changes to the information by applying to the information at least one of the one or more post-submission validation rules.

11. The method of claim 10, wherein storing one or more credit application validation rules comprises storing one or more pre-submission finance source rules and one or more post-submission finance source rules, the finance source rules specified by at least one finance source to be applied to the information in the credit application to the finance source.

12. The method of claim 11, wherein storing one or more credit application validation rules comprises storing ones or more pre-submission global validation rules and one or more post-submission global validation rules, the global validation rules to be applied to information in credit applications to a plurality of finance sources.

13. The method of claim 12, wherein storing one or more credit application validation rules comprises storing one or more validation error rules.

14. The method of claim 13, further comprising:
validating at least a portion of the information included in the credit application by applying to the information at least one of the one or more pre-submission validation error rules prior to submitting the credit application to the at least one finance source; and
delaying submission of the credit application to the at least one finance source in the event of violation of at least one pre-submission validation error rule until the invalid information is corrected by the vendor.

15. The method of claim 14, further comprising:
after submitting the credit application to a finance source, validating the one or more received changes to the information in the submitted credit application by applying at least one or more post-submission validation error rules to the changed information; and
in the event of violation of at least one post-submission validation error rule, requesting the vendor (i) to resubmit the credit application to the finance source for approval, or (ii) to modify the changed information such that it complies with post-submission validation error rules.

16. The method of claim 13, wherein storing one or more credit application validation rules comprises storing one or more validation issue rules.

17. The method of claim 16, further comprising:
prior to submitting a credit application to the at least one finance source, validating at least a portion of the information, included in the credit application by applying to the information at least one of the one or more pre-submission validation issue rules;
displaying on the computer operated by the vendor a status indication associated with a violation of at least one pre-submission validation issue rule;
submitting the credit application to the at least one finance source; and
notifying the finance source of violation of at least one pre-submission validation issue rule.

18. The method of claim 17, further comprising:
after submitting the credit application to a finance source, validating the one or more received changes to the information by applying at least one or more post-submission validation issue rules to the changed information; and
notifying the finance source of violation of at least one post-submission validation issue rule.

19. The method of claim 14, further comprising after receiving an approval of the credit application from a finance source, validating the at least one of credit application information and a credit decision information by applying at least one of one or more post-submission validation error rules and one or more post-submission validation issue rules.

20. The method of claim 10, wherein the asset acquisition is a lease or a purchase.

21. The method of claim 10, wherein the asset is a vehicle.

22. A system for indirect financing of an acquisition by a customer of an asset offered by a vendor with financing provided by an independent finance source, the system comprising:
a database comprising finance source information for each of a plurality of finance sources, the finance source information corresponding to each of the finance sources including one or more finance source specified rules to be applied to information in a credit application to the finance source;
a credit aggregation management system operatively coupled to the database, the credit aggregation management system providing access to the finance source on behalf of the customer seeking the credit approval, wherein the credit aggregation management system facilitates acquisition of the credit approval from the financial source by receiving credit application information from the vendor; and
a credit application validation engine operable to validate at least a portion of the information included in the credit application by applying to the information at least one of the one or more finance source specified rules for at least one finance source before submitting a credit application to the at least one finance source for approval.

23. The system of claim 22, wherein after submitting the credit application to the at least one finance source for approval, the credit application validation engine is configured (i) to receive from the vendor one or more changes to the information in the submitted credit application and (ii) to validate at least a portion of the changed information in the submitted credit application by applying to the information at least one of the one or more finance source specified rules.

24. The system of claim 23, wherein the one or more finance source specified rules include one or more validation error rules, wherein upon, detection of violation of one or more validation error rules, the credit aggregation management system is configured not to submit the credit application to the at least one finance source until the invalid portion of information in the credit application is corrected by the vendor.

25. The system of claim 24, wherein one or more finance source specified rules include one or more validation issue rules, wherein upon detection of violation of one or more validation issue rules, the credit aggregation management system is configured (i) to submit the credit application to the at least one finance source for approval and (ii) notifying the finance source of violation of at least one finance source specified validation issue rule.
